(19) United States
(12) Patent Application Publication
(10) Pub. No.: US 2012/0316935 A1
(43) Pub. Date: Dec. 13, 2012

(54) REBATE AND DISCOUNT SYSTEM FOR PROMOTION OF SERVICE VENDORS USING DENSITY OF WORK SITES

(76) Inventor: Seth FEUERSTIN, Woodbridge, CT (US)

(21) Appl. No.: 13/493,896

(22) Filed: Jun. 11, 2012

Related U.S. Application Data
(60) Provisional application No. 61/495,691, filed on Jun. 10, 2011.

(51) Int. Cl. G06Q 30/02

(52) U.S. Cl. 705/14.13; 705/14.39

(57) ABSTRACT

A system and method for offering promotional price discounts, rebates, and other offers to help service vendors improve the density of work sites for which they deliver services is disclosed. An electronic platform enables vendors that provide work site services to create and manage pricing schedules, rebates, and discount offers based on the geographic density of work sites. The vendor price lists can include a base price, and rebates and discounts from the base price increase based on the number of customer work sites within a given geographical area. The electronic platform enables vendors to advertise the geographically variable pricing schedules to clients, and to track customer patronage. The electronic platform allows customers to view and purchase vendor offered services from the discount pricing schedules, forward recommendations for vendor services to others, and submit requests for a discounted service to vendors.

### RELATED APPLICATIONS

This application claims priority to U.S. Provisional Application No. 61/495,691, filed on Jun. 10, 2011.

### BACKGROUND OF THE INVENTION

The present invention is directed to a system and method to help service vendors improve the density of work sites for which they deliver services. For ease of terminology hereafter, the location where such a service is provided will be termed a “work site” and the businesses who provide such services will be termed a “work site vendor.” The current practices for customer acquisition, service provision, product sales and vendor choice available for businesses in the work site vendor industry are inefficient and limited. Work site vendors spend much down time and money traveling from work site to work site, invariably passing potential new clients in need of their services.

For instance, a typical lawn mowing service currently drives from customer work site to customer work site. Such services attempt to schedule, to the extent possible, services to be performed at nearby work sites on the same day to limit down time and increase the number of jobs that can be done in that day. When customers are located near each other, this has historically derived from happenstance or word of mouth referrals. Further, rarely do lawn mowing vendors service more than a handful of customers in the same neighborhood, let alone the same block. Thus, a large portion of their day will be spent packing up their equipment for driving to another remote work site, as opposed to performing paid-for service.

The above example of the inefficiencies present in a typical lawn mowing service shows how the current state of the industry for work site vendors is inefficient for the individual vendors, increases carbon emissions, and wastes time. While work site vendors desire to have multiple jobs at nearby work sites to reduce down time and travel costs, few are able currently to establish such a client base. Presently, there are two primary methods by which work site vendors may attempt to solicit geographically-close clients-word of mouth recommendations from current clients and the door-to-door distribution of fliers and circulars. Both are not highly efficient.

Customers, on the other hand, often find it difficult to identify local vendors who excel and are already in their neighborhoods. While they can seek referrals online or from neighbors, such referrals are not readily coupled with pricing or discount information. Further, as consumers are becoming increasingly environmentally conscious, they would be grateful to find ways to reduce their carbon footprints while finding a reliable and cost-effective service provider.

Customer discounts and rebates have long been known and used to drive consumer activity. As the Internet becomes more ingrained in daily life, discounts and rebates for many aspects of life have been invented, such as for more efficient display of products for online storefronts, online coupon or group discount sites, and online rating sites for those who sell services or products. This invention creates a system and database to allow for solutions to other problems that are longstanding.

### SUMMARY OF THE INVENTION

The present disclosure relates to systems and methods for improving energy efficiency and lowering energy costs as well as offering promotional price discounts, rebates, and other promotions to help service vendors improve the density of work sites for which they deliver services. The invention further relates to an electronic platform that enables businesses who provide services at the different work sites of their various customers to create and manage pricing schedules or other rebates or discounts that base pricing for services upon the geographic density of the work sites, thereby permitting the businesses to attract customers within a geographic area, to save travel costs, to increase the number of jobs that may be performed in a given time period, and offer lower prices to consumers based upon the efficiencies reaped from using the platform.

In particular, the present invention is adapted to solve a problem that has long hampered businesses that serve as vendors of consumer services that are provided to customers at their location of work or residence. These consumer services include, but are not limited to, lawn mowing, snow shoveling, snow plowing, painting, gutter cleaning, carpet cleaning, drapery cleaning, chimney cleaning, power washing, Spring/Fall yard clean up, pool cleaning, pool opening/closing, house cleaning, delivering of items (groceries, dry cleaning, etc.), providing of house calls by therapeutic or health care professionals, house repair (e.g., by HVAC technicians, plumbers, or handyman services) and other similar services.

### BRIEF DESCRIPTION OF THE DRAWINGS

FIG. 1 is a block diagram of an embodiment of the discount pricing system of the present invention.

FIG. 2 is a block diagram of an embodiment of the electronic platform of the present invention.

### DETAILED DESCRIPTION OF THE INVENTION

The present invention facilitates multiple solutions to the above-described and other inefficiencies by enabling a more efficient allocation of resources by work site vendors, and more efficient pricing for customers of such vendors, thus increasing overall efficiency in the marketplace. The invention provides work site vendors using the platform (henceforth, a “member vendor” or “member work site vendor”) with the ability to establish a pricing system that offers discounted pricing based on the proximity of customer work sites to one another.

The present invention is an electronic platform that enables work site vendors to create and manage geographically-based discount programs, and methods associated with the use of such a platform.

The electronic platform may comprise a website hosted by a host computer or server, wherein the website is accessible over a network. The host computer or server executes a computer program stored on a computer readable medium. The computer program contains executable instructions that allow the host computer or server to interact with an electronic database, and that allow for the host computer or server to update the website interface with information from the electronic database. Vendors and customers may upload information to the website through a user interface, and this information is then stored in the electronic database. The user interface may be a personal computer, PDA, smartphone, laptop, tablet, or any other computing device that allows access to the internet.

The website of the electronic platform displays information relating to work site services, including vendor names, vendor work locations, customer names, customer locations, vendor pricing schedules, and customer desired services or pricing. The user interface allows vendors to upload pricing schedules for work site services, and further allows vendors to display advertisements or discount information for the services. The user interface additionally allows customers to upload requests for services or requests for specified discount amounts. The electronic platform further includes options for a customer to send recommendations to others through email, text message, or other forms of electronic communication.

The platform enables a member work site vendor to establish and advertise through the platform a variable pricing schedule for one or more of the work site services they provide. The pricing schedules include a base price, and definitions regarding how customers may qualify for one or more geographically-based discounts from the base price depending upon the location of the customer's respective work site(s). The base prices can be flat, or variable based upon some feature other than geographic location, such as lot size, driveway size, house size, day of week, etc. The defined discounts can include rebates, price discounts, or other incentives (e.g., a free add-on service, such as lawn clippings removal) based upon the geographic location of the customer's work site. Most preferably, the vendor defines price discounts from base prices that increase based on the number of customer work sites within a certain proximity to each other. The platform will also offer formulae for standardized pricing that vendors may choose to use which will be informed by data on transactions already occurring or known market data.

For example, a member vendor can offer customers a 10% discount if their work site is within the same neighborhood of another customer's work site, a 15% discount if their work site is within 5 sites/houses of another customer's work site, and a 20% discount if their work site is within 5 sites/houses of at least 2 or more other customer's work sites. In such embodiments, the discount is applied to each customer that qualifies, not just new customers. Thus, for example, if a next door neighbor of an existing customer of a member vendor signs up with the member vendor for service, the platform credits the 15% discount to both the existing and new customer. This provides an incentive for current customers to promote the service to their neighbors.

In another example, the member vendor can be a lawn cutting service that charges as a base price X per quarter of an acre to mow lawns. The discount schedule can be defined such that the base price is reduced by 5% if someone within five homes also uses their service (for both of them), 10% if 4 use it, 15% if 6, etc.

Alternatively or additionally, a member vendor can define a discount for customers having work sites within a pre-defined geographic “home” radius (e.g., 5 miles from the main office of the work site vendor), which discount may further be variable depending upon the number of customers that sign up for the product of service within the radius.

Other definitions that can optionally be supported by the platform for utilization by member vendors include maximum discount levels, such that customers cannot combine different discounts to get below a floor price, and new client incentives, such that member vendors may offer special up-front or one-time discounts to encourage new clients to initiate service with them.

The platform according to preferred embodiments of the present invention is an online web-enabled portal that allows member vendors and both potential and existing customers to create accounts. The member vendors use their accounts to define their geographically-variable pricing schedules, advertise them to clients, and track levels of patronage by customers within the geographic areas proscribed within their respective discount definitions. The member vendor can choose the discount schedule structure, and the platform system optionally can be configured to make recommendations based on default discount structures and/or average pricing for a given industry.

Optionally and preferably, the portal is configured to provide a front end interface to consumers that supplies real-time quotes to potential customers based upon the address of their work site such that they can receive a quote regarding for which level of discount, if any, they will qualify. The platform of the invention thus enables a member vendor to track customer locations and activity, and manage a geographically-based promotional program that offers discounts, and to adjust based on predetermined behavior.

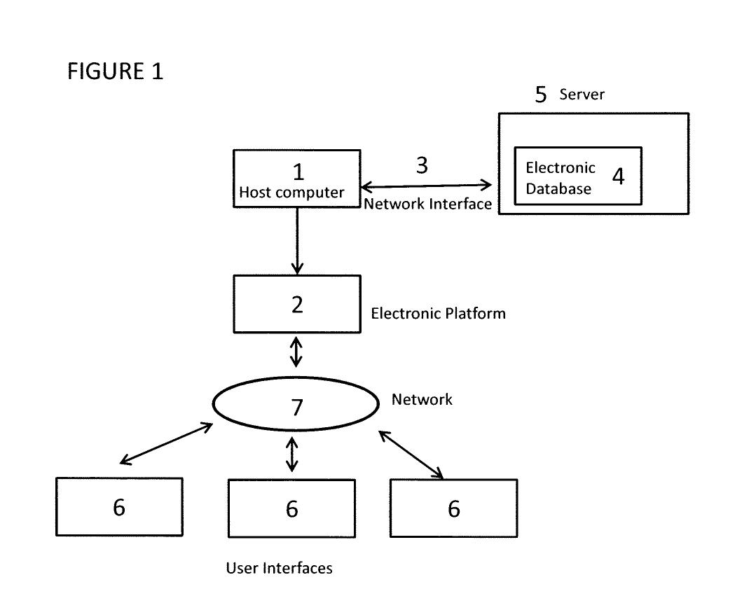

As seen in FIG. 1, the platforms utilized in embodiments of the inventions are implemented via conventional computing and information systems, networks, and database structures to support web hosting of consumer and member vendor front end websites, and to support the back end functionality described herein relating to the tracking of customers and the defining and application of geographically variable pricing schedules. The system includes a computer 1, which executes a program stored on a computer readable medium to host the electronic platform 2. A network interface 3 connects the computer 1 to an electronic database 4 stored on a server 5. Alternatively, the electronic database may be stored in a memory of the computer 1. The electronic platform 2 is accessible by user interface devices 6 over a network 7. The network may be a wired or wireless communication network, and may comprise the interne or a local area network. Optionally, the system is configured with the ability to track the results of different discount programs over time period and “learn” which discounts work best for incentivizing new customers. As a result of these platforms and methods of using the same, work site vendors can thus more easily obtain the efficiencies associated with having multiple clients with geographically close work sites.

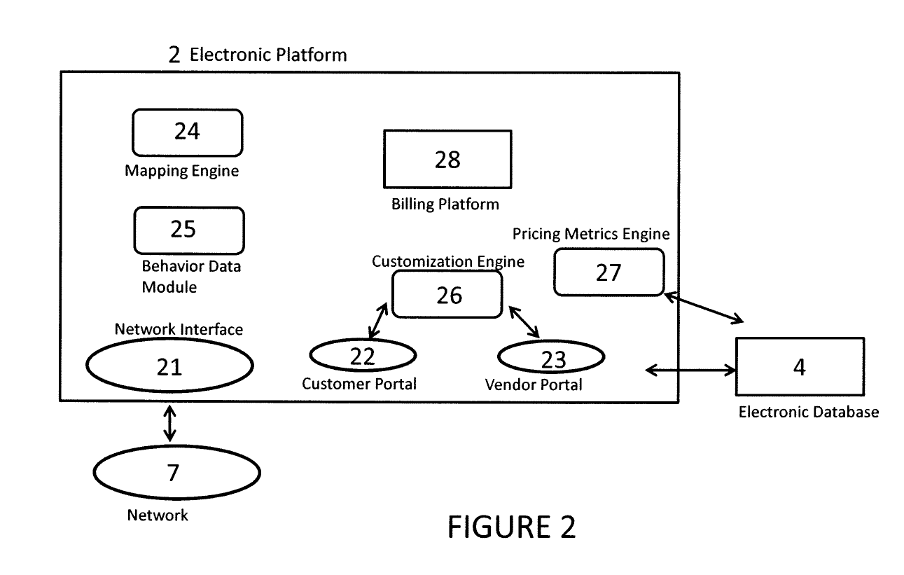

As seen in FIG. 2, the electronic platform 2 of the present invention includes a link to the electronic database 4, and a network interface 21 for bidirectional communication over the network 7. A customer portal 22 and a vendor portal 23 enable member customers and member vendors to access the electronic platform. The electronic platform may include a mapping engine 24 which organizes and analyzes customer and vendor geographic locations. A behavior data module 25 tracks customer purchases and activity, and tracks vendor provided services. A customization engine 26, accessible through the customer and vendor portals, allows member vendors and member customers to customize their personal information and to customize information regarding the pricing or advertisements of services. Customers may request discounts through the customization engine, and vendors may list special discount offers or adjust existing discount offers. A pricing metrics engine 27 accesses the customer and vendor information stored in the database, and automatically adjusts discount offers within the electronic platform based at least in part on the number of customers accepting the offer, and the geographic location of the customers. An electronic billing platform 28 provides online commerce support, such as billing and collection services for member vendors to allows them to use online credit card billing, electronic, invoicing, collection, pricing, and service scheduling.

The platforms according to the present invention also may permit consumers to form a virtual community with work site vendors, allowing the vendors to craft, manage, and direct promotional programs at interested customers, and in turn allowing interested customers to opt view the service offerings of multiple member vendors that are advertising geographic discounts on work site vendor services.

Optionally, member vendors and customers may be permitted to create accounts via the front end websites, whereby information regarding services offered, signed up for, sold, bought, etc., can be stored for later access in the accounts.

Certain embodiments of the platform according to the invention manage a database of customer, work site vendor, and associated discount program and customer activity information, and have a vendor portal for whereby member vendors can define or modify pricing schedules. Further, the platform could offer a purchaser portal for customers to view work site service offerings from multiple member vendors. Preferably, the customer portal would allow each purchaser to log in (or otherwise provide identifying information) and check to see which level of discounts they currently qualify for each participating vendor. Optionally, the customer portal would be configured to enable customers to make purchases or schedule services with certain member vendors, and/or view customer reviews and/or ratings for member vendors. The system may sell data about which discounts have proven to be most efficient to vendors.

In embodiments of the invention wherein the platform is utilized to establish a community of different work site vendors and customers, the platform can optionally be configured with electronic systems adapted to compile usage and activity information. For example, such system may be provided with logic to track and thereby “learn” how particular customers, or particular classes of customers, respond to certain kind of discount schedules or types. As on community and ratings websites like Angie's List and Yelp, ratings and reviews may optionally be supported. In such embodiments, vendors may be rated publicly by customers with ratings and/or reviews searchable and/or viewable by other member customers. Further, customers in turn may be rated by vendors for view by other vendors. The platform may also optionally be further configured to provide online commerce support, such as billing and collection services for member vendors to allows them to use online credit card billing, electronic, invoicing, collection, pricing, service scheduling, etc.

The electronic platform of the present invention may also include an electronic billing platform to provide the online commerce support, such as billing and collection services for member vendors to allow them to use online credit card billing, electronic, invoicing, collection, pricing, and service scheduling. This billing platform facilitates billing of customers for the purchases made or services scheduled. Customers may enter payment information, such as a credit card number or bank account number, into the billing platform. This payment information may be entered as part of a customer profile that is then saved in the electronic information database accessible by the electronic platform. The payment information may then be automatically accessed by the billing platform each time the customer makes a purchase or requests service. The billing platform transmits this billing information to the vendor providing the service or completing the purchase in order to facilitate vendor collection of the payments. Alternatively, the billing platform may automatically transfer the payment from the customer to an account associated with the vendor. The vendor account information may also be stored in the electronic database.

One particular example regarding how a platform according to the present invention can be configured and operate is as a service directed toward offered graduated discounts within a particular geographic area which is triggered by an initial scheduling or contracting of service within that area. In the case of a carpet cleaner vendor who offers to clean carpets in the house of customers, the vendor can offer discounts to that customer and others if nearby consumers also use them on that day. For example if the cleaning had a base price of $100, a communication could be sent to other member customers in the vicinity (comprising a geographic area that can be outlined by the vendor or automatically to a default vicinity by the platform) advertising discounts if they schedule service on that day. If a second and third customer signs up, then all three would be notified that they would get a specific discount. Likewise, if a snow plow company has been contracted to plow a single house others in the area could sign up and each customer in that area would get discounts or rebates that increase as more of them contract.

Another particular example regarding how a platform according to the present invention can be configured and operate is as a service directed toward integrating geographic-based discounts with services and/or online communities that review service providers, such as the service called Angie's List. Angie's List and other similar reviewing companies and communities offers vendor ratings, reviews, and, at times, discounts. While they may have zip code information on customers and use that to identify vendors serving the customer's general geographic area, they lack any ability to provide geographic based discount schedules as described herein. Platforms according to the present invention can be integrated with such online review communities to provide to customer members offers of graduated discounts within zip codes and, more particularly, within certain geographic distances of other customers accepting the offer, for example within a neighborhood. In this example, a positively rated vendor could list that they would offer 2% off for each new person who uses them for snow removal in radius of an address on a map. Pricing would be based on a formula of driveway and/or walkway length. The software can also offer standard pricing methods to vendors and customers (e.g., called “what should this cost” based on vendors nationwide). For every person who signs up the $100 expected cost would decline by $2 until a floor price chosen by the vendor is reached (e.g., $50). The vendor benefits by having the ability to remove snow from more homes using the same amount of time (and far less gas and vehicle wear and tear). The vendor increases total revenue, customers spend less, and carbon emissions and dangerous weather compromised travel time are reduced.

What is claimed is:

1. A method for improving the density of vendor work sites, comprising the steps of:
providing an electronic platform accessible by vendors and customers through a user interface;
uploading vendor pricing schedules and advertisements to the electronic platform for one or more work site services provided by the vendors, wherein each pricing schedule includes a base price;
uploading a geographically-based discount program for each vendor pricing schedule, wherein each discount program presents discounts from the base price which depend on customer location and the number of customers within a pre-determined geographic area of that location.

2. The method of claim 1, wherein the discounts vary based on the number of customers within a geographic area, and the physical proximity of said customers within the area.

3. The method of claim 1, further comprising:
tracking the results of the discount programs over time;
analyzing the results of the discount programs to determine how many new customers each discount program attracted;
determining which discount programs work best for incentivizing new customers; and
providing vendors access to the analyzed results through the electronic portal.

4. The method of claim 1, further comprising providing a selectable option displayed on the user interface which allows customers to rate the vendor services.

5. The method of claim 4, wherein the customer ratings are displayed on a website, and wherein customers may further upload reviews of vendors to the website.

6. The method of claim 1, further comprising customers transmitting recommendations to others to participate in the discount programs; wherein the acceptance of the recommendation is acknowledged by the electronic platform and wherein the pricing schedule contained in the electronic platform is updated based on the number of recommended customers who join into a discount program.

7. The method of claim 1, wherein the electronic platform calculates the energy and cost savings for each vendor based on the number and location of customers participating in each work site discount program, and wherein the electronic platform communicates this energy and cost savings information to each vendor for each discount program implemented through the electronic platform.

8. The method of claim 2, wherein each customer within a predetermined geographic area receives further discounts as the number of customers participating in the discount program through the electronic platform increases.

9. The method of claim 1, wherein the electronic platform is further configured to provide online commerce support, including billing and collection services for member vendors.

10. A system for improving the density of vendor work sites, comprising:
an electronic platform configured as a web-enabled portal;
an electronic database stored on a server, wherein the electronic database communicates with the electronic platform;
at least one vendor portal and at least one customer portal accessible on the electronic platform;
wherein the at least one vendor portal includes vendor pricing schedules and advertisements for one or more work site services provided by the vendors, and wherein each pricing schedule includes a base price; and
wherein the electronic platform is configured to display selectable options for a geographically-based discount program for each vendor pricing schedule on the at least one customer portal, wherein each discount program presents discounts from the base price which depend on customer location and the number of customers within a pre-determined geographic area of that location.

11. The system of claim 10, wherein the electronic platform is configured to allow vendors and potential customers to create member accounts, and wherein the member accounts are stored in the electronic database.

12. The system of claim 11, wherein the vendor portal is configured to allow vendor members to list new discount offers on the electronic portal, and is further configured to allow vendor members to adjust existing discount offers.

13. The system of claim 10, wherein the electronic platform is configured to collect information regarding customer locations and activity, and wherein the electronic platform manages vendor scheduling of services within a predetermined geographic area based on the collected customer locations and activity.

14. The system of claim 10, wherein the electronic portal is configured to automatically adjust the pricing schedule of discount offers based on the number of customers within a geographic area, and the physical proximity of said customers within the area.

15. The system of claim 10, wherein the customer portal allows member customers to view discounts associated with their geographic location, and wherein the customer portal automatically alerts customer members of new discount offers from vendors within their geographic area based on the customer's previous activity and purchases.

16. The system of claim 10, wherein the customer portal allows member customers to send invitations and recommendations related to the discount programs to others.

17. The system of claim 10, wherein the customer portal is configured to enable customers to make purchases and schedule services with participating member vendors, and to enable customers to post and view customer reviews and ratings for the member vendors.

18. The system of claim 10, further comprising an electronic billing platform configured to provide online commerce support, including billing and collection services.

19. The system of claim 10, wherein the electronic database stores customer, vendor, discount program, and customer activity information.
